(19) United States
(12) Patent Application Publication
(10) Pub. No.: US 2004/0226115 A1
(43) Pub. Date: Nov. 18, 2004

(54) Method and kit for preparing a last for footwear

(76) Inventors: Larus Gunnsteinsson, Reykjavik (IS); Arni T. Ingimundarson, Reykjavik (IS); Gunnsteinn Larusson, Seltjarnarnes (IS)

Correspondence Address: BACON & THOMAS, PLLC, 625 SLATERS LANE, FOURTH FLOOR, ALEXANDRIA, VA, 22314

(21) Appl. No.: 10/772,382

(22) Filed: Feb. 6, 2004

Related U.S. Application Data
(60) Provisional application No. 60/445,447, filed on Feb. 7, 2003.

(51) Int. Cl. B29C 33/40

(52) U.S. Cl. 12/146 L; 264/226

(57) ABSTRACT

A method and kit for preparing a last for footwear. The method includes applying an elastomeric liner having a smooth continuous inner surface on a foot to be molded inner surface and optionally spacers for pads or orthotics as needed, applying a pliable, hardenable sock structure over the liner in close conformity with the foot, liner and spacers, activating the hardening agent of the sock structure, removing the sock structure now having a mold cavity in the shape of the foot with the liner forming the inner surface of the mold cavity and with the mold cavity including the spacer geometries after the sock structure has hardened, pouring a settable last forming compound into the cavity of the sock structure and removing the sock structure with the liner after the settable last forming compound has cured, thereby yielding a positive impression of the foot that is directly usable as a last. A kit according to the present invention includes a combination of elements and materials used to carry out the process.

### BACKGROUND OF THE INVENTION

1. Field of the Invention

The present invention relates to a method and kit for preparing a last for making footwear.

2. Background of the Related Art

A last is generally a solid, three-dimensional foot-shaped form or model over which material used to make an article of footwear, in particular a shoe, is shaped and assembled, commonly referred to a “dressing a shoe.” Generally, the last dictates the size, shape and contour of the footwear such that the interior form of the footwear will reflect the exterior shape of the last and generally yield a good fit for a particular foot, taking into account hose or other elements that may be worn or required on a foot or within the shoe.

Of particular importance is the use of foot lasts for custom footwear. Custom footwear made on a last should comfortably support a specific foot in a natural running or walking gait for optimal comfort and performance. The custom footwear should mitigate and avoid discomfort and pressure points, as well as excessive stress on muscles, ligaments and tendons of the foot and leg. In achieving its objective, the last must be precisely shaped, sized and graded to produce useable footwear for a specific user. Accordingly, the shape and configuration of the last is critical in order to make footwear comfortable and provide adequate support for the foot.

Many prior art techniques are available for the construction of a last for custom footwear. A well-known technique involves the preparation of a plaster mold by casting a foot with plaster and subsequently removing the cast from the foot to create a negative impression of the foot. A positive impression of the foot is formed by pouring another plaster or settable material into the negative impression, and upon removal thereof, the positive impression is modified by material addition or removal in the event the positive impression does not adequately represent the foot for the production of footwear for the modeled foot. The positive impression is then finally polished and available as a last.

A drawback to this technique is that the positive impression often requires tedious modifications to adequately represent the foot and adequate space for toes, dorsal area, etc. In addition, the molded last may be fragile and may not exhibit sufficient strength required for a permanent last when making custom footwear. In a variant of this technique, a wood or plastic based last can be carved or otherwise shaped by a skilled artisan using the positive impression as a model. This variant, however, still requires the tedious process of preparing a positive impression to accommodate pads and is largely dependent upon the skill of the artisan.

In another technique described in U.S. Pat. No. 5,228,164, granted Jul. 20, 1993 to Graf et al., a fabric coated or impregnated with a hardenable material is wrapped around a foot to form a thin and smooth shell corresponding to the shape of the foot. The shell is then removed from the foot and used as a positive model of the foot such that the shell need not be used as a negative mold in order to prepare a positive impression of the foot. The shell is thus used as the last for making custom footwear. The shell will typically have a form which is slightly larger than the actual foot, and its use as a last will be somewhat affected by this characteristic. A possible disadvantage of this technique is that the shell requires sufficient strength to withstand pressures involved when making the footwear due to its inherently thin construction. Also, if such a shell is used as a negative impression of the foot, as is known in the art, there is the risk that a curable settable liquid material poured therein will adhere to the fabric when hardening, or at least have a rough surface thereby limiting the immediate use of the resultant last.

Recently, techniques have been devised to use computer-aided design and manufacturing in the preparation of a last for custom footware. Such techniques involve scanning a foot, creating a three dimensional model of the foot, and carving the last on a computer controlled mill or lathe. Computer manufacturing of a last, however, is expensive, is not readily portable, and requires a substantial investment in machinery and expertise to implement.

It may be seen from the foregoing, therefore, that a need persists for an improved method for constructing a last for custom footwear which avoids or substantially reduces the shortcomings of the techniques heretofore known.

### SUMMARY OF THE INVENTION

In accordance with the principles and concepts of the invention, there is provided an improved method for preparing a last for footwear. The method includes applying a flexible, elastomeric liner over a foot on or an optional inner stocking which appropriate toe and dorsal spacers have been installed, installing a moldable sock structure impregnated with or otherwise carrying or containing a settable or curable resin over the liner on the foot, conforming the sock structure with the foot contours (i.e., molding the sock and resin to the foot) and activating the resin to harden the sock structure. The hardened molded sock structure and liner are together removed from the foot by appropriate techniques, creating a lined inner mold cavity having a smooth, non-stick surface that defines a negative impression of a foot including any desired spacers. The elastomeric liner, removed from the foot with the hardened sock structure, lines the walls of the cavity, which cavity effective becomes a smooth, non-stick mold for directly casting a foot last form due to the smooth nature of the inner surface of the elastomeric liner. A curable or settable liquid last forming mixture is then poured into the lined cavity and hardened to form a positive impression of the lined cavity. The positive impression can then be used directly as a last upon removal from the molded sock structure.

If the footwear to be dressed on the last requires additional space around the actual foot for any purpose, the last can be directly molded with appropriated contours for accommodating such space by installing core elements or spacers corresponding in shape, size and contour within the sock structure between the foot and the liner, preferably prior to installation and hardening of the sock structure on the foot. Variable size or shape core elements can be used, permitting variation of the geometry of the core elements before and during hardening of the sock element on the foot. The usual toe and dorsal spacers may also be installed inside the liner prior to donning the hardenable sock structure.

The core elements according to the inventive process may be applied directly on the foot at appropriate locations corresponding to the anticipated space requirements, or may be installed with or on an inner stocking first donned on the foot on which the last is to be modeled. The elastomeric liner then will be installed over the inner stocking and core elements, followed by the uncured or unhardened sock structure. Upon curing or hardening of the sock structure and its removal from the foot as described above, the interior mold cavity of the sock structure will correspond with the shape of the foot as modified by the core elements (including the usual dorsal and toe spacer, or any other internal adaptation that may be required for a particular foot).

The present invention also contemplates a kit for preparing lasts for custom footwear that includes one or more mold forming sock structures impregnated with, carrying or containing a curable resin or settable compound and easily conformable to a foot. The sock structure can be preformed and pre-impregnated with a water curable resin, for example, and can be hermetically sealed within a casing. In addition, the kit may also includes a thin elastomeric liner configured and dimensioned to conform to a human foot when donned thereover, for example a liner having a smooth silicone inner film surface, positionable between a foot and the sock structure, so as to form a smooth liner within the cavity of the sock structure. Furthermore, a curable or settable last forming compound also may be included with the kit for use as a pourable moulding material to be placed in the mold cavity of the hardened sock structure with its elastomeric liner after removal of the sock structure from the foot. Other elements that may be included in such a kit are thin stockings to be used when the patient's skin is sensitive, and spacers.

The use of an elastomeric liner, for example made of elastomer textile or other elastic, compliant material having a smooth silicone film on its inner surface, provides an interface between the foot and the hardenable sock structure that protects the foot from the resin or hardening compound of the sock structure and eases removal of the molded and hardened sock structure from the foot. In addition, the elastomeric liner serves an interface between the last forming molding compound and the hardened sock structure and facilitates separation of the molded last from the hardened sock mold cavity while leaving a smooth, fully functional outer surface on the molded last. Thus, the invention provides a simplified and economical method and components for directly creating a negative impression of a foot with any required spaces for internal orthotic or other elements and such negative impression can be used to directly mold or cast a positive impression of the foot that is directly or substantially directly useable as a last.

The elastomeric liner may be incorporated within the sock structure so that the sock structure may be donned together with a liner such as silicone directly over a smooth inner stocking that has previously been donned over the foot and on which appropriate pads or orthotic elements have been applied in predetermined positions. Any appropriate system that will provide an integrated smooth liner for the sock structure may be utilized either as a separately applied layer or as a layer that is integrated with the sock structure. The liner need only be smooth, compliant and readily separable from the last molding compound after it has been placed within the mold cavity of the sock structure and during removal of the sock structure from the molded last.

A preferred last for footwear in accordance with this invention comprises a hardened molded last substantially conforming to the cavity of the hardened structure sock lined with the elastomeric liner and with contours representing any toe and dorsal spaces, orthotic elements and pads or other elements needed to model the foot for which the last is made. According to the invention, an anatomically accurate last can be created in less time, and with fewer steps and cost, than currently known techniques.

### BRIEF DESCRIPTION OF THE DRAWINGS

FIG. 1 is a perspective view illustrating the application of toe and dorsal core spacer elements on an optional inner stocking installed on a foot of a patient in preparation for molding a custom last in accordance with a method aspect of the invention;

FIG. 2 is a perspective view illustrating the application of an elastomeric liner on a foot over the core elements and stocking of FIG. 1;

FIG. 3 is a perspective view illustrating the application of a compliant sock structure with a curable resin or hardenable compound over the elastomeric liner and foot as seen in FIG. 2;

FIG. 4A is a rear view illustrating a hardened sock structure and elastomeric liner separated from a foot on which they have been placed, with the sock structure shaped and hardened in close conformity with the foot to produce a last molding cavity;

FIG. 4B is a perspective view illustrating the separated, shaped and hardened sock structure of FIG. 4A;

FIG. 5 is a schematic view illustrating a shaped and hardened sock structure forming a lined mold cavity, with a liquid last forming settable compound being poured therein;

FIG. 6 is a perspective view of a last formed by using the method of the present invention;

FIG. 7 is a cross-sectional view of a mold cavity of a hardened sock structure with an elastomeric liner;

FIG. 8A is a rear view illustrating a parting or tear strip on a heel portion of a shaped and hardened sock structure with liner; and

FIG. 8B is a front view illustrating a parting or tear strip on a front portion of a shaped and hardened sock structure with liner.

### DETAILED DESCRIPTION OF THE INVENTION

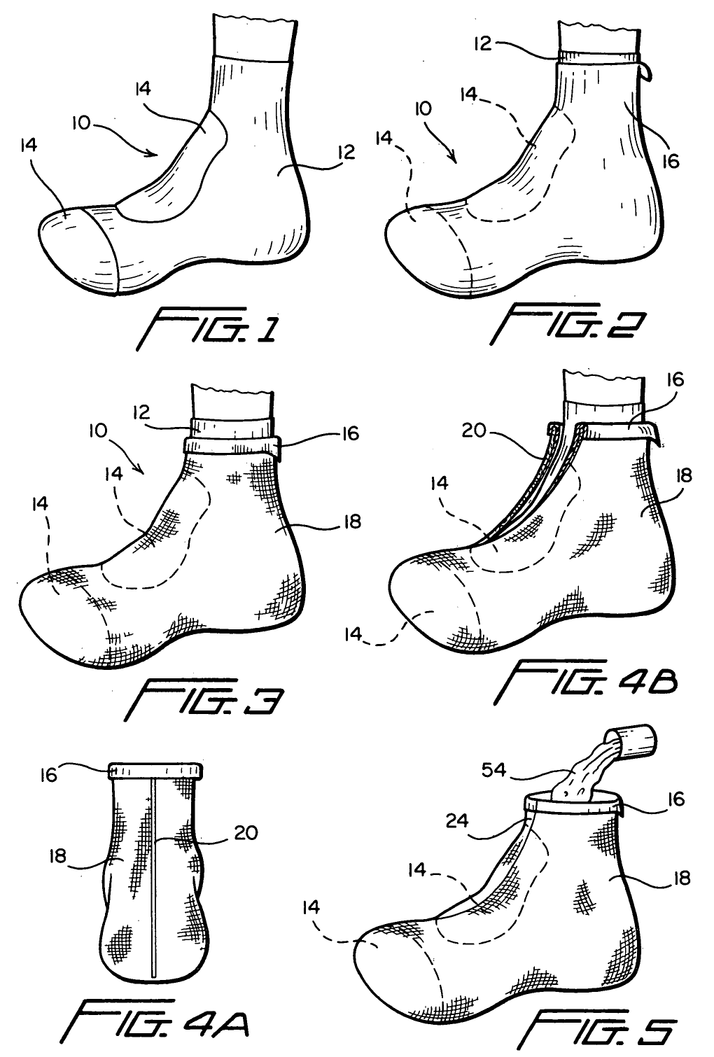

Referring to the drawings, there are shown steps in preparing a last for custom footwear according to the invention. For the purposes of example only, the method will be described in connection with the formation of a last for a left foot requiring one or more pads or other orthotic elements in a footwear to be formed on the last. FIGS. 1-8B illustrate the basic method and components of the present invention for preparing a last for custom footwear.

In accordance with a basic preferred method of the invention for making a last for custom footwear, FIG. 1 shows a first step wherein an optional thin inner compliant stocking 12 is donned on a foot 10 in close conformity with the foot. Toe and dorsal core elements or spacers 14 are subsequently applied onto the inner stocking 12 at predetermined locations in accordance with known last design principles. Alternatively, the inner stocking may be omitted and the spacers 14 may be placed directly on a foot to be modeled. Next, a thin, resilient, compliant, elastomeric liner having a smooth, non-stick inner surface 16, as shown FIG. 2, is donned over the stocking 12 (or the foot directly) and the core elements 14 so that it closely conforms to the shape of the foot 10. A moldable sock structure 18, for example formed of woven glass or polyester fibers, impregnated with or otherwise containing a curable, hardenable resin such as a suitable water activatable resin, is then donned over the liner 16 and molded to conform to the foot 10 as shown in FIG. 3. Appropriate lubricating material may be used on the surface of the inner stocking or foot to facilitate later separation of the sock structure and the lining from the foot and eventual last to be molded in the sock structure. The resin of the sock structure 18 may be activated before or after being applied to the foot 10. Upon activation and hardening (or curing) of the resin, the sock 18, now a rigid structure, and the elastomeric liner with its smooth inner surface 16 are removed from the foot 10.

The smooth inner surface of the elastomeric liner 16 lines the interior cavity surface of the hardened sock structure 18, and the combination of the structure 18 and liner 16 defines an internal cavity 50 that corresponds with a desired negative impression of the foot 10, as shown in FIG. 7, that can be used as a mold cavity.

When the hardened structure 18 is cut or divided for example along portions 20, as shown in FIGS. 4A and 4B, the hardened sock structure can be gently spread apart and separated from the foot 10. The cut portions 20 are subsequently rejoined. The liner 16 may or may not be divided for removal of the sock structure 16.

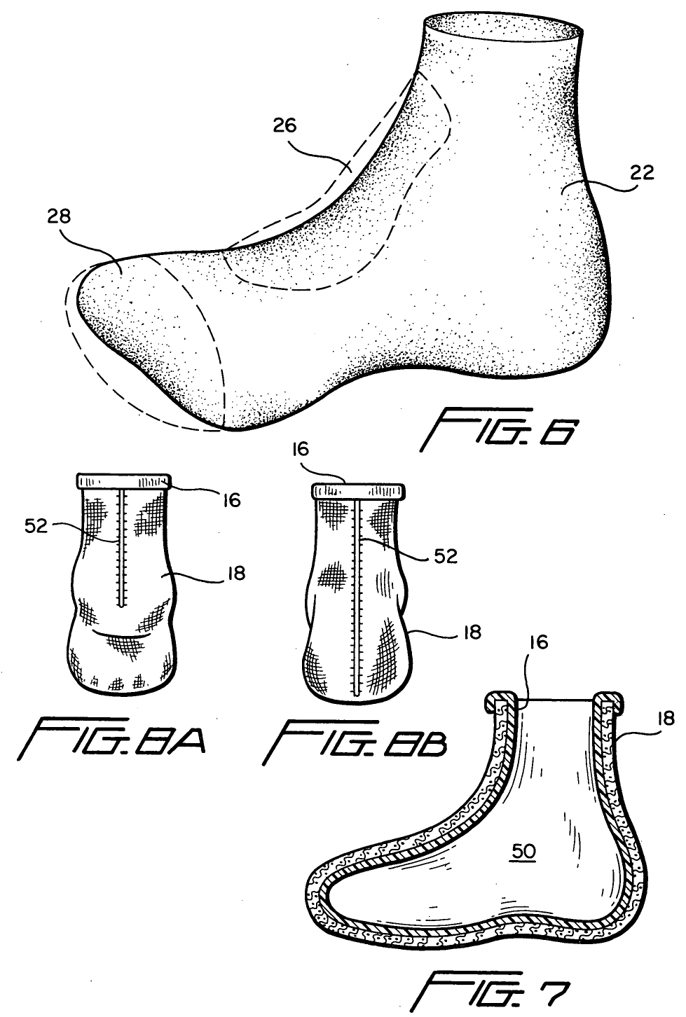

A liquid settable compound, for example a polyurethane mixture known as PETILIN 54 then is poured into the mold cavity 50 of the hardened sock structure, as represented in FIG. 5. The compound 54 cures and/or hardens to form a positive impression 22 of the foot 10, precisely conforming to the shape of the lined cavity 50, including the contours of the core spacers 14 that have left their impressions in the mold cavity. The hardened sock structure 18 and the liner 16 are separated from the positive impression 22 at which point the positive impression 22 is essentially ready for use as a last 22 in the production of custom footwear for the foot from which the impression was made. Due to the smooth, non-stick inner surface of the elastomeric liner in the mold cavity of the mold structure 18 the exterior surface of the last is immediately ready for use or at least substantially ready with minor adjustments. The smooth inner surface of the liner 16 preferably is silicone, but appropriate non-stick, smooth materials formed of other compositions could be used, and coatings or separation facilitating materials may also be used on the inner surface.

In further detail, FIG. 1 shows a thin, compliant inner stocking 12 covering a foot with core spacer elements 14 compliant with the underlying foot 10 positioned at predetermined locations of the stocking 12 to provide space for the dorsal and toe areas of the shoe to be formed with the last to be produced in accordance with the invention. The inner stocking is optional to provide protection for the foot and further facilitates the application of the core elements 14. The core elements 14 may be positioned at a variety of locations of the foot 10 other than the dorsal and toe areas, and their positioning is largely dependent on corresponding predetermined regions of the footwear where tailored stabilizing pads, orthotic appliances or cushioning elements are to be located to thereby yield a desired anatomical last shape for the eventual footwear. The core elements 14 may be covered with smooth, non-stick material, such as silicone, nylon, rubber or cloth, that protects the foot from resin when the inner stocking is not used and facilitates their later separation from the liner 16.

The inner stocking 12 closely conforms to the exterior of the foot and may be a thin, smooth material, such as silicone, nylon, rubber or cloth, that protects the foot from resin and does not adhere to the liner 16 either inherently or by using a separation coating or lubricant. The core elements 14 may be sewn into or otherwise affixed onto the inner stocking 12, or removably attached with corresponding hook and loop type fasteners, tape, adhesive or other appropriate methods. The inner stocking 12 may be omitted and the core elements applied directly to the foot 10 before donning of the liner 16.

FIG. 2 illustrates a liner 16 with a smooth inner surface donned over the optional inner stocking 12 and the core elements 14 of FIG. 1. The liner 16 preferably is a relatively thin, elasticized fabric having a smooth, non-porous, moisture impervious, inner film of silicone elastomer adhered or bonded with the fabric and providing a smooth inner surface of the liner so as to provide an interface between the foot 10 (or inner stocking 12), on one hand, and the sock structure 18 and its curable or hardenable resin, on the other hand. The liner 16 is configured to stretch over and effectively closely conform to the foot 10 (with any core spacer elements) and to become bonded with the curable or hardenable resin of the sock structure 18 on its outer surface. In one embodiment, the liner 16 can be provided in the form of a rolled tubular sock-like member open at one end to receive a foot and closed at a toe end, that may be donned by being unrolled over the foot 10. U.S. Pat. No. 6,485,776 describes an exemplary method for making the preferred material of liner 16. Alternatively, the liner 16 and moldable sock structure 18 can be integrated into a unitary assembly prior to installation on the foot 10, whereby the liner 16 defines the internal surface of the cavity of the sock structure 18. The inner film, layer or material of the liner is designed or selected to be readily releasable from the last molding compound to be placed in the mold cavity of sock structure 18.

FIG. 3 shows the resin impregnated hardenable sock structure 18 donned over the liner 16 and molded on the foot so as to effectively closely conform to the foot 10 with any associated core spacers. The sock structure 18 with its associated resin or hardenable material initially may be in the form of a pre-impregnated, soft and compliant rolled tube of pre-impregnated resin that is donned by being rolled over the foot 10. Alternatively, the sock structure 18 may be in the form of an open ended sleeve and several other parts that interconnect with the sleeve, such as a separate toe portion or heel portion.

The sock structure 18 preferably comprises woven fiberglass or polyester yarns or fibers in the form of a textile, which will provide sufficient structural strength and dimensional stability, when the resin impregnated in the sock structure has been activated and cured, to form a negative mold for a last after the sock structure 18 has been removed from the foot 10, and to enable the cavity 50 in the sock structure to be filled with a settable liquid compound that will form the last, and then separated from the last molding compound. The material of the sock 18 and the associated resin should have sufficient moldable characteristics to enable the sock 18 to conform closely to the foot 10 when donned both before and after hardening of the resin either by its internal properties or by manipulation, for instance manual shaping and pressure, or by using tapes or sheets, applied over the sock structure 18 during curing of the resin to minimize gaps, wrinkles and folds in the donned sock 18, as well as air gaps. For example, the sock structure could be a woven material such as fiberglass possibly including elastomeric fibers for enhancing flexibility and elasticity of the sock structure.

The sock structure 18 preferably is impregnated with a curable or hardenable water curable resin of known compositions, for example water curable resins of the kind described in U.S. Pat. No. 5,972,036, which is incorporated herein by reference, prior to use or prior to packaging in a kit (to be described below), or can be coated with such resin at the time of use by using methods such as dipping the sock in or spraying the material of the sock with the resin. The resin should be selected so that it does not cause chemical irritation or the skin of the foot or generate excessive, uncomfortable heat during curing. The resin should also be sufficiently reactive with an activator, such as water, to insure rapid hardening of the sock structure 18 once the resin has been activated and the sock structure applied to the foot 10. The resin can be a type that is activated by other methods known in the art, such as photolytically, thermally, chemically or any other known method.

The resin may be activated immediately prior to the sock strucure 18 being donned on the foot 10, for example by dipping the sock 18 into water (assuming the resin is water activated) and removing excess water by wringing out or dabbing the sock 18. Alternatively, the sock structure 18 may be sprayed with activating water either prior to or after being donned on the foot 10. Soon after donning the sock structure 18 on the foot 10 and activating the resin, the resin will cure and harden, becoming a sufficiently rigid structure with the substrate fiber elements to enable the sock structure 18 to be eventually removed as a unit from the foot 10 and used as a mold in a manner to be described. During hardening of the resin, the foot 10 should be maintained in a neutral position that will likely serve as the optimal position for molding the last and forming the eventual footwear. An appropriate lubricant (i.e., talcum powder or the like, may be used on the surface of the inner liner 16.

FIGS. 4A and 4B each show the cured and hardened sock structure 18 parted to enable its removal from the foot without adversely affecting the mold cavity within the sock structure. In FIG. 4A, there is shown a cut line 20 along the back portion of the hardened sock structure 18 and in FIG. 4B there is shown a cut line 20 along the front portion of the hardened sock structure 18. The cut line can be effected by any suitable cutting tool, or alternatively a tear line, or zipper or strip may be used with the sock structure to enable easy parting of the hardened sock structure. The sock structure is not limited to being cut or parted only along the portions shown in FIGS. 4A and 4B, and may be cut or separated in any manner that permits the hardened structure to be readily removed from the foot and rejoined along cut portions without substantially distorting the overall shape of the mold cavity within the structure. In accordance with one example, the liner 16 is not parted during removal of the sock structure 18 from the foot 10, but simply distends elastically to enable removal of the sock structure from the foot. When the hardened sock structure 18 is restored to its shaped form, the liner 16 follows the sock structure and maintains the integrity of the inner surface of the mold cavity formed in the sock structure 18. In such a procedure, the sock structure 18 could be cut before the hardening agent has fully hardened or cured. Alternatively, the liner 16 can be parted with the sock structure and then appropriately rejoined after removal from the foot to restore the closed mold cavity in the sock structure 18.

Numerous alternative techniques may be used to remove the hardened mold sock structure 18 from the foot 10. In accordance with another technique just described above, the structure 18 with elastomeric liner 16 may be cut just before the resin completely hardens, cured then cut portions may be rejoined and sealed together with a filler such as, for example, silicone. Upon complete hardening of the resin of the sock structure 18, the filler is cut and the hardened structure is gently spread apart and slid off the foot.

When the structure 18 is cut prior to completely hardening of the resin it may be maintained in a slightly split configuration. When the resin of sock structure 18 completely cures and hardens, the silicone elastomer liner 16 may be distended at the parting line as the hardened structure 18 is separated from the foot 10, with the continuity of the liner 16 remaining intact.

Alternatively, as shown in FIGS. 8A and 8B, the sock structure 18 may be constructed such that at least one strip 52 is formed along a predetermined region thereof, such as the dorsal portion or heel region of the foot, that is thinner than the rest of the sock structure 18. The thinner region facilitates the cutting or parting of the sock structure 18 upon hardening of the resin component. In another approach, the sock structure 18 is constructed with at least one tear strip or zipper-like element 52 provided as an integral part of the structure 18 and positioned along a predetermined region thereof, such as the dorsal portion or heel region. In this latter embodiment, the strip 52 can be a metallic tear strip, zipper, or wire, or a plastic or textile strip that is impervious to resin impregnation and different from the primary substrate material of the sock structure 18. Upon hardening of the resin of the structure 18, the or each strip can be easily cut or torn from the sock 18 in order to enable the hardened sock structure 18 to be parted and separated from the foot 10.

FIG. 5 shows the hardened sock structure 18 and the associated liner 16 rejoined along the part lines 20 in regions 24. The hardened sock structure can be restored essentially to its original molded shape with the use of hot melt or tape adhesives, or any other method that does not substantially distort the overall shape of the mold cavity within the structure.

Upon rejoining the hardened sock structure 18, a liquid last molding compound such as, for example, a curable polymeric mixture 54, such as a polyurethane mixture known as PETILIN, may be poured into the mold cavity 50 of the hardened sock structure 18, as shown in FIG. 5. The molding compound 54 is permitted to cure, harden or set, ultimately setting to form a rigid positive impression 22 of the foot 10 and associated core spacers as defined by the mold cavity 50 of the hardened sock structure 18. After the last molding compound is hardened, the hardened sock structure 18 is removed from the positive impression thereby leaving a fully formed last 22 corresponding to the foot 10 and associated core elements and having a smooth outer surface ready for dressing a custom shoe.

FIG. 6 shows the last 22 removed from the hardened sock structure 18. The places where the core spacer elements 14 lay during the setting of the hardened sock structure are shown in phantom lines 26, 28. The shape of the molded last 22 can be further modified if desired by removing material therefrom by using methods such as sanding, carving or machining, or by bonding material thereon, but otherwise it is intended that the last will be substantially ready for use when separated from the sock structure mold cavity.

The above-described components for forming a foot last in accordance with the inventive method may be provided in kit form for use in implementing the method, according to another inventive aspect of the invention. The kit could optionally be supplied with instructions for its use and include containers, or holders for the various above-described components, as well as an attractive external packaging.

Such a kit, for example, would include one or a plurality of inner stockings 12, core spacers 14, liners 16, and pre-impregnated sock structures 18, last casting or molding material, activating material for any curable resin used with the sock structure, adhesives as needed and appropriate tools for handling, shaping, mixing, applying and removing various materials to be used in the inventive process, all of which have been described above. The liners 16 could be integrated with the sock structures 18 in the kit, and packaged as a ready-to-use component needing only resin activator to be used.

The combination of preferred exemplary materials and methods embodying the present invention have now been described. It will be appreciated by those skilled in the art that certain substitutions of equivalent materials and the use of modified equivalent method steps are possible without departing from the spirit and scope of the invention. Thus, the scope of the invention should not be limited to the products and method steps described herein, but only by the properly interpreted scope of the claims appended hereto.

We claim:

1. A method for preparing a last useful for producing custom footwear, comprising the steps of:
applying a compliant liner element having a smooth continuous inner surface over a foot for which the footware is intended;
applying a pliable hardenable resin carrying sock structure over the liner element, and confirming said sock structure and liner element to the foot;
hardening the sock structure to a rigid form;
removing the hardened sock structure and liner from the foot to thereby leave an inner mold cavity of the sock structure defining a negative impression of the foot with the smooth, continuous inner surface of the liner element forming the inner surface of the mold cavity;
placing a settable last forming material in the mold cavity and permitting the last forming material to set and harden; and
removing the sock structure from the hardened last forming material so that the last forming material corresponds with a positive impression of the mold cavity and includes a smooth outer surface.

2. The method according to claim 1, further comprising the step of applying core spacer elements at predetermined regions of the foot prior to application of the liner element.

3. The method according to claim 2, further comprising applying an inner stocking over the foot prior to the application of the liner element, with the core spacer elements being attached to the inner stocking.

4. The method according to claim 2, wherein the core spacer elements are applied to the toe and dorsal regions of the foot.

5. The method according to claim 2, including forming the core spacer elements so they are compliant with the form of the underlying foot.

6. The method according to claim 1, further comprising the step of dividing portions of the hardened sock structure and spreading apart the divided portions to enable removal of the hardened sock structure from a foot.

7. The method according to claim 6, further comprising the step of rejoining the divided portions upon removal of the hardened sock structure from a foot to restore the integrity and form of the mold cavity.

8. The method according to claim 1, wherein the last forming material comprises a curable polymer.

9. The method according to claim 1, wherein the sock structure is a porous substrate impregnated with a curable resin.

10. The method according to claim 9, wherein the sock structure substrate is a textile formed of glass or polyester fibers.

11. The method according to claim 1, wherein the compliant liner element and the sock structure are applied together as an integrated assembly on the foot.

12. The method according to claim 1, wherein the compliant liner element comprises an elastomeric material, and wherein the smooth continuous inner surface comprises a silicone layer.

13. A kit for preparing a last for producing footwear, comprising:
a sock structure carrying an activatable hardenable compound, said sock structure and compound adapted to be conformed to a foot for which the footware is intended and to be activated to a hardened sock structure;
a compliant flexible liner having a smooth continuous inner surface adapted to be conformed to a foot and to be positioned as an intermediate layer between a foot and the sock structure; and
a pourable and settable last forming material suitable for forming a last when set and hardened.

14. The kit according to claim 13, wherein the liner and sock structure are integrated into a unitary sock structure, the liner defining an internal surface of the unitary sock structure.

15. The kit according to claim 13, further comprising compliant core spacer elements configured to be positioned at predetermined regions of a foot.

16. The kit according to claim 13, further comprising an inner stocking member suitable to protect skin from core spacers and elements of the sock and liner.

17. The kit according to claim 16, wherein the core spacer elements on the inner stocking correspond at least to toe and dorsal regions of a foot.

18. The kit according to claim 13, wherein the settable last forming material comprises polyurethane.

19. The kit according to claim 13, wherein the sock structure comprises a glass fiber textile.

20. The kit according to claim 19, wherein the sock structure comprises elastomeric fibers woven into the glass fiber textile.

21. The kit according to claim 13, wherein the liner comprises an elastomeric textile coated on its inner surface with a continuous, smooth layer of silicone.
